(19) United States
(12) Patent Application Publication
(10) Pub. No.: US 2006/0074522 A1
(43) Pub. Date: Apr. 6, 2006

(54) Method and system of automatic dispatch

(76) Inventors: Po Hsiung Liang, Jhongli City (TW); Hsien-Jung Hsu, Taipei City (TW); Ming Wang, Chunghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/954,505

(22) Filed: Sep. 30, 2004

(51) Int. Cl. G06F 7/00

(52) U.S. Cl. 700/223

(57) ABSTRACT

A method of automatic dispatch for a batch manufacturing tool fed by carriers. The method first compares carrier occupancy with a predetermined optimum occupancy. If a result obtained is less than the optimum, distribution information of the objects is reserved and the objects in the carriers are combined. Next, the combined objects are processed in the manufacturing tool. After processing, the objects are separated in the carriers according to the distribution information.

### BACKGROUND

The present invention relates to dispatch methods, and in particular to a computer-implemented method of automatic dispatch for a batch manufacturing tool fed by carriers.

In manufacturing foundries, such as semiconductor product manufacturing foundries, batch manufacturing tools are indispensable. Conventionally, a batch manufacturing tool is carrier-based for object processing. For example, if a batch manufacturing tool processes four carriers simultaneously, the four carriers are loaded into the manufacturing tool whether full or not. If carriers are loaded while empty, operations of the batch manufacturing tool are inefficient. Since batch manufacturing is costly for semiconductor product foundries, the operative effect is an important issue.

For better batch manufacturing tool utilization, object combination and separation in carriers is executed manually to resolve the mentioned dispatch problems. Considerate labor resources are devoted to manual object combination and separation operations, making them an important concern for manufacturers.

### SUMMARY

An embodiment of the invention provides a method for overcoming automatic dispatch which first determines whether to combine carriers for processing in a batch manufacturing tool. If so, distribution information of the objects is recorded. Next, the method combines objects in the carriers and the combined objects are processed in the batch manufacturing tool. Finally, the objects are separated in the carriers according to their distribution information.

### BRIEF DESCRIPTION OF THE DRAWINGS

The present invention can be more fully understood by reading the subsequent detailed description and examples with references made to the accompanying drawings, wherein:

FIG. 1 is a flowchart of a method of automatic dispatch for a batch manufacturing tool fed by carriers according to an embodiment of the invention.

FIG. 2 is a diagram of a machine-readable storage medium storing a computer program performing automatic dispatch for a batch manufacturing tool fed by carriers according to an embodiment of the invention.

FIG. 3 is a diagram of a system of automatic dispatch for a batch manufacturing tool fed by carriers according to an embodiment of the invention.

FIG. 4 is a diagram of an exemplary implementation of the system for automatic dispatch for a batch manufacturing tool fed by carriers.

### DESCRIPTION

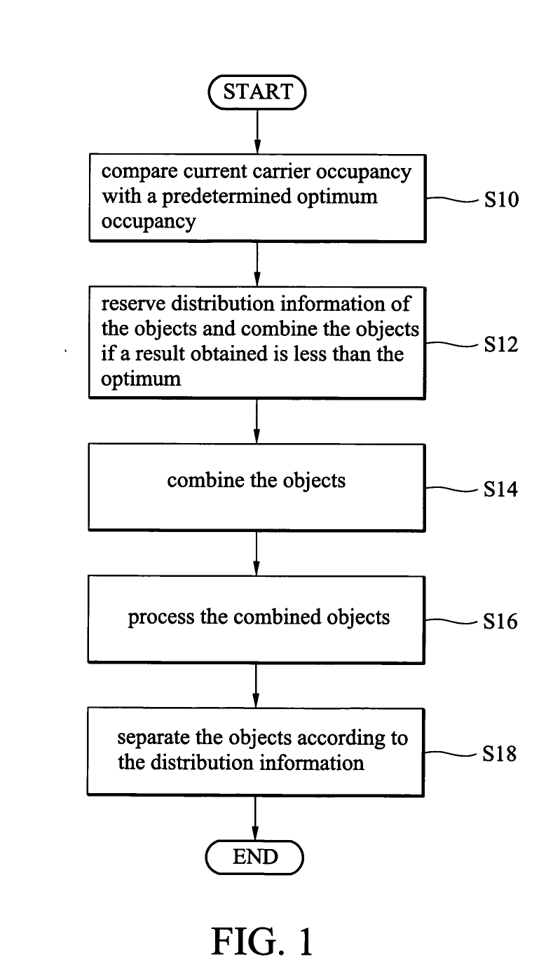

FIG. 1 is a flowchart of a method of automatic dispatch for a batch manufacturing tool fed by carriers according to an embodiment of the invention. First, current carrier occupancy is compared with a predetermined optimum occupancy (step S10). The predetermined optimum occupancy is recorded in a database. That is, it is checked if carriers are full, with carriers loaded into the batch manufacturing tool as full as possible. If so, distribution information of the objects is reserved (S12).

Because the objects may be separated in the next batch manufacturing tool, the distribution information is reserved for the object separation after processing.

Next, the method combines the objects in the carriers (S14), after which, the combined objects are processed in the manufacturing tool (S16). Finally, the objects are separated in the carriers according to their distribution information (S18). The combination can be performed by a sorter tool. In a semiconductor product foundry, the objects can be wafers and the batch manufacturing tool can be a semiconductor product manufacturing tool.

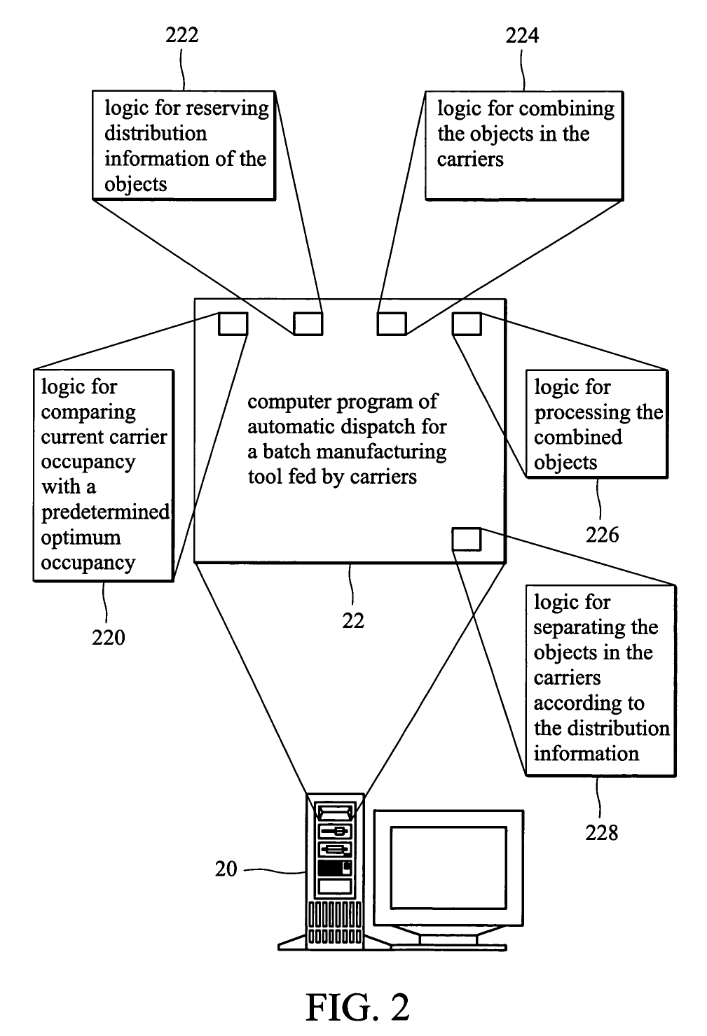

The previously described method can be implemented as a computer program. FIG. 2 is a diagram of a machine-readable storage medium 20 storing a computer program 22 executing automatic dispatch for a batch manufacturing tool fed by carriers. The computer program 22 comprises logic for comparing current carrier occupancy with a predetermined optimum occupancy 220, and reserving distribution information of the objects 222, and combining the objects in the carriers 224. The computer program 22 may further comprise logic processing the combined objects 226 and separating the objects in the carriers according to the distribution information 228.

Furthermore, an integrated circuit product manufactured by the previously mentioned method is provided. In one embodiment, an integrated circuit product can be manufactured by a batch manufacturing tool fed by carriers. The batch manufacturing tool adopts an automatic dispatch method which comprises the previously mentioned steps. For example, the materials for manufacturing the integrated circuit product can be loaded into the carriers. The manufacturing tool then executes the steps to manufacture the integrated circuit product. The integrated circuit product may be manufactured by other manufacturing tools or processes. The previously mentioned method is part of the whole manufacturing process of the integrated circuit product.

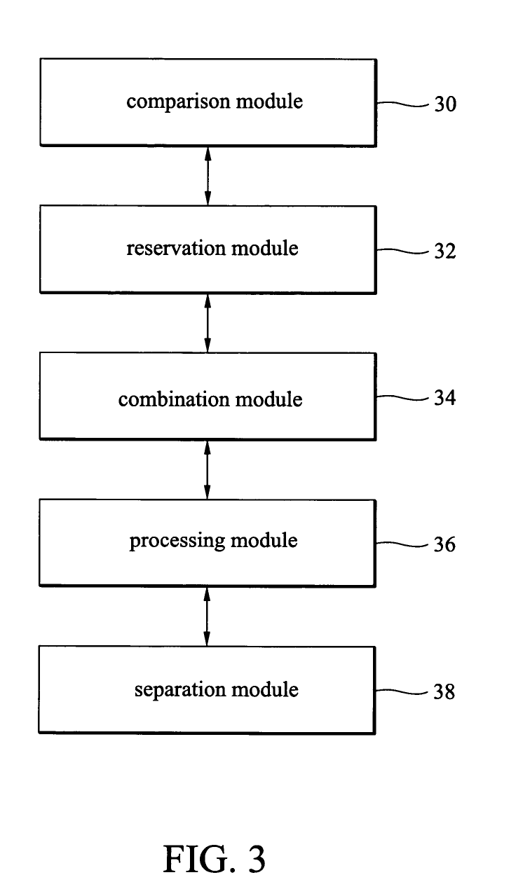

FIG. 3 is a diagram of a system of automatic dispatch for a batch manufacturing tool fed by carriers according to an embodiment of the invention, comprising a comparison module 30, a reservation module 32, a combination module 34, a processing module 36, and a separation module 38. The comparison module 30 compares current carrier occupancy with a predetermined optimum occupancy. The predetermined optimum occupancy may be recorded in a database, such as a MES database.

The reservation module 32 reserves distribution information of the objects. The combination module 34 combines the objects in the carriers. The combination module 34 may be implemented in a sorter tool.

The processing module 36 processes the combined objects in the batch manufacturing tool. The separation module 38 separates the objects in the carriers according to the distribution information after processing. In a semiconductor product foundry, the objects are wafers and the batch manufacturing tool is a semiconductor product manufacturing tool.

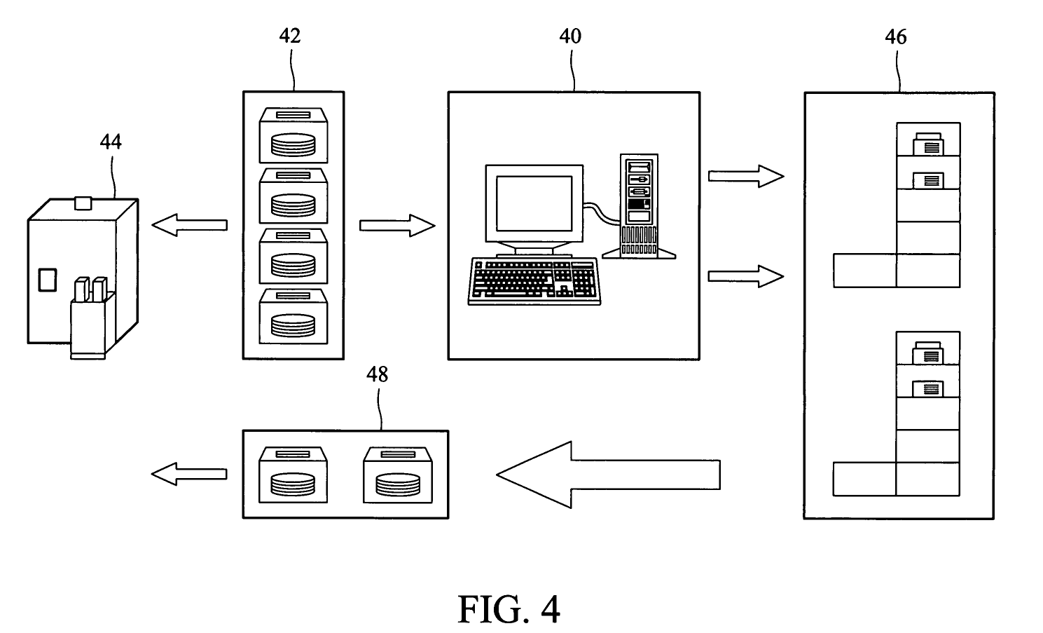

FIG. 4 is a diagram of an exemplary implementation of the system for automatic dispatch for a batch manufacturing tool fed by carriers. The system can be implemented in a semiconductor product foundry, wherein objects 42 are wafers and the batch manufacturing tool 44 is a semiconductor product manufacturing tool. The comparison module 30, the reservation module 32, and the combination module 34 are implemented in a computer system 40. The computer system is coupled to a MES database.

When the objects 42 reach batch manufacturing tool 44, the computer system 40 first compares a current carrier occupancy with a predetermined optimum occupancy recorded in the MES database. If a result obtained is less than the optimum, the computer system 40 reserves distribution information of the objects 42.

The combination module 34 may be implemented as a sorter tool 46. The sorter tool 46 combines objects 42 in the carriers. The processing module 36 processes the combined objects 48 in the batch manufacturing tool 44. The separation module 38 separates the objects in the carriers according to the distribution information after processing. The processing module 36 and separation module 38 can be implemented in the computer system 40 or in the batch manufacturing tool 44.

If batch manufacturing tools or carriers are changed, systems and methods of the present invention can be revised to fit actual requirements of production line.

Methods and systems of the present invention, or certain aspects or portions of embodiments thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer-implemented method of automatic dispatch for a batch manufacturing tool fed by carriers, comprising using a computer to:
compare current carrier occupancy with a predetermined optimum occupancy; and
reserve distribution information of the objects and combine the objects in the carriers if a result obtained is less than the optimum.

2. The computer-implemented method of automatic dispatch for a batch manufacturing tool fed by carriers of claim 1, further comprising using a computer to:
process the combined objects in the batch manufacturing tool; and
after processing, separate the objects in the carriers according to the distribution information.

3. The computer-implemented method of automatic dispatch for a batch manufacturing tool fed by carriers of claim 1, wherein the predetermined optimum occupancy is recorded in a database.

4. The computer-implemented method of automatic dispatch for a batch manufacturing tool fed by carriers of claim 1, wherein the distribution information is reserved in a database.

5. The computer-implemented method of automatic dispatch for a batch manufacturing tool fed by carriers of claim 1, wherein the combination of the objects is performed via a sorter tool.

6. The computer-implemented method of automatic dispatch for a batch manufacturing tool fed by carriers of claim 1, wherein the objects are wafers.

7. The computer-implemented method of automatic dispatch for a batch manufacturing tool fed by carriers of claim 6, wherein the batch manufacturing tool is a semiconductor product manufacturing tool.

8. An integrated circuit product manufactured by an automatic dispatch method for a batch manufacturing tool fed by carriers, the method comprising:
compare current carrier occupancy with a predetermined optimum occupancy; and
reserve distribution information of the objects and combine the objects in the carriers if a result obtained is less than the optimum.

9. The integrated circuit product manufactured by an automatic dispatch method for a batch manufacturing tool fed by carriers of claim 8, the method further comprising:
process the combined objects in the batch manufacturing tool; and
after processing, separate the objects in the carriers according to the distribution information.

10. The integrated circuit product manufactured by an automatic dispatch method for a batch manufacturing tool fed by carriers of claim 8, wherein the predetermined optimum occupancy is recorded in a database.

11. The integrated circuit product manufactured by an automatic dispatch method for a batch manufacturing tool fed by carriers of claim 8, wherein the distribution information is reserved in a database.

12. The integrated circuit product manufactured by an automatic dispatch method for a batch manufacturing tool fed by carriers of claim 8, wherein the combination of the objects is performed via a sorter tool.

13. The integrated circuit product manufactured by an automatic dispatch method for a batch manufacturing tool fed by carriers of claim 8, wherein the objects are wafers.

14. The integrated circuit product manufactured by an automatic dispatch method for a batch manufacturing tool fed by carriers of claim 13, wherein the batch manufacturing tool is a semiconductor product manufacturing tool.

15. A system of automatic dispatch for a batch manufacturing tool fed by carriers, comprising
a comparison module, comparing current carrier occupancy with a predetermined optimum occupancy; and
a combination module, coupled to the comparison module, reserving distribution information of the objects and combining the objects in the carriers if a result obtained is less than the optimum.

16. The system of automatic dispatch for a batch manufacturing tool fed by carriers of claim 15, further comprising:
a processing module, coupled to the combination module, processing the combined objects in the batch manufacturing tool; and
a separation module, coupled to the processing module, after processing, separating the objects in the carriers according to the distribution information.

17. The system of automatic dispatch for a batch manufacturing tool fed by carriers of claim 15, wherein the predetermined optimum occupancy is recorded in a database.

18. The system of automatic dispatch for a batch manufacturing tool fed by carriers of claim 15, wherein the distribution information is reserved in a database.

19. The system of automatic dispatch for a batch manufacturing tool fed by carriers of claim 15, wherein the combination module is a sorter tool.

20. The system of automatic dispatch for a batch manufacturing tool fed by carriers of claim 15, wherein the objects are wafers.

21. The system of automatic dispatch for a batch manufacturing tool fed by carriers of claim 20, wherein the batch manufacturing tool is a semiconductor product manufacturing tool.
